(19) United States
(12) Patent Application Publication
(10) Pub. No.: US 2015/0061952 A1
(43) Pub. Date: Mar. 5, 2015

(54) Broadband Antenna

(71) Applicant: Wistron NeWeb Corporation, Hsinchu (TW)

(72) Inventors: Yu-Yu Chiang, Hsinchu (TW); Yen-Cheng Chen, Hsinchu (TW); Kuan-Hsueh Tseng, Hsinchu (TW); Chia-Tien Li, Hsinchu (TW)

(21) Appl. No.: 14/329,996

(22) Filed: Jul. 14, 2014

(30) Foreign Application Priority Data
Sep. 3, 2013 (TW) 102131720

(51) Int. Cl. H01Q 5/00

(52) U.S. Cl. CPC H01Q 5/0041
USPC 343/749

(57) ABSTRACT

A broadband antenna for a wireless transceiver includes a grounding unit for grounding; a radiating part; a signal feed-in element for transmitting a radio signal to the radiating part in order to emit the radio signal via the radiating part, where a grounding terminal of the signal feed-in element is electrically connected to the grounding unit; a feed-in point, located on the radiating part; a capacitor, electrically connected between the feed-in point and the signal feed-in element; and an inductor, having a first terminal electrically connected to the capacitor.

### BACKGROUND OF THE INVENTION

1. Field of the Invention

The present invention relates to a broadband antenna, and more particularly, to a broadband antenna in which passive elements are utilized to excite a resonance effect of the antenna, thereby increasing the bandwidth of a high frequency band and improving the impedance matching of the antenna in a low frequency band.

2. Description of the Prior Art

Antennas are widely used in electronic products to emit or receive radio waves for conveying or exchanging wireless signals. Generally, electronic products with wireless communication functionalities, such as laptops, tablet PCs, personal digital assistants (PDAs), mobile phones and wireless base stations, utilize embedded antennas to access wireless networks. In order to let the users access wireless communication networks more conveniently, the antenna bandwidth should be as broad as possible so that more communication protocols can be complied with, while the antenna size should be minimized to meet the downsizing trend of electronic products. With the evolution of wireless communication technology, it has become a basic requirement for a wireless communication system to send and receive large amounts of data. Since different wireless communication protocols may have different operational frequency bands, it is desirable that a single antenna can support multiple operational frequency bands for different wireless communication protocols.

Therefore, how to design a miniature antenna which has broad bandwidth for complying with the operational frequency band requirements of different wireless communication protocols is an important topic to be addressed and discussed.

### SUMMARY OF THE INVENTION

An objective of the present invention is to provide an antenna which utilizes passive elements in the proximity of the feed-in point of the antenna, thereby improving the bandwidth and reducing the antenna dimension.

An embodiment of the present invention discloses a broadband antenna used for a wireless transceiver. The broadband antenna includes a grounding unit for grounding; a radiating part; a signal feed-in element for transmitting a radio signal to the radiating part in order to emit the radio signal via the radiating part, wherein a grounding terminal of the signal feed-in element is electrically connected to the grounding unit; a feed-in point located on the radiating part; a capacitor electrically connected between the feed-in point and the signal feed-in element; and a first inductor having a first terminal electrically connected to the capacitor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a broadband antenna according to an embodiment of the present invention.

FIG. 1B illustrates a plane of the broadband antenna shown in FIG. 1A.

FIG. 1C illustrates another plane of the broadband antenna shown in FIG. 1A.

FIG. 1D illustrates a vertical section of the broadband antenna shown in FIG. 1A.

FIG. 1E is a diagram of a voltage standing wave radio (VSWR) of the broadband antenna shown in FIG. 1A.

FIG. 1F is a diagram of a radiation efficiency of the broadband antenna shown in FIG. 1A.

FIG. 2 is a schematic diagram of a broadband antenna according to an embodiment of the present invention.

FIG. 3A is a schematic diagram of a broadband antenna according to an embodiment of the present invention.

FIG. 3B illustrates a plane of the broadband antenna shown in FIG. 3A.

FIG. 3C illustrates another plane of the broadband antenna shown in FIG. 3A.

FIG. 4 is a schematic diagram of a broadband antenna according to an embodiment of the present invention.

FIG. 5 is a schematic diagram of a broadband antenna according to an embodiment of the present invention.

FIG. 6 is a schematic diagram of a wireless communication device equipped with the broadband antenna shown in FIG. 1A.

### DETAILED DESCRIPTION

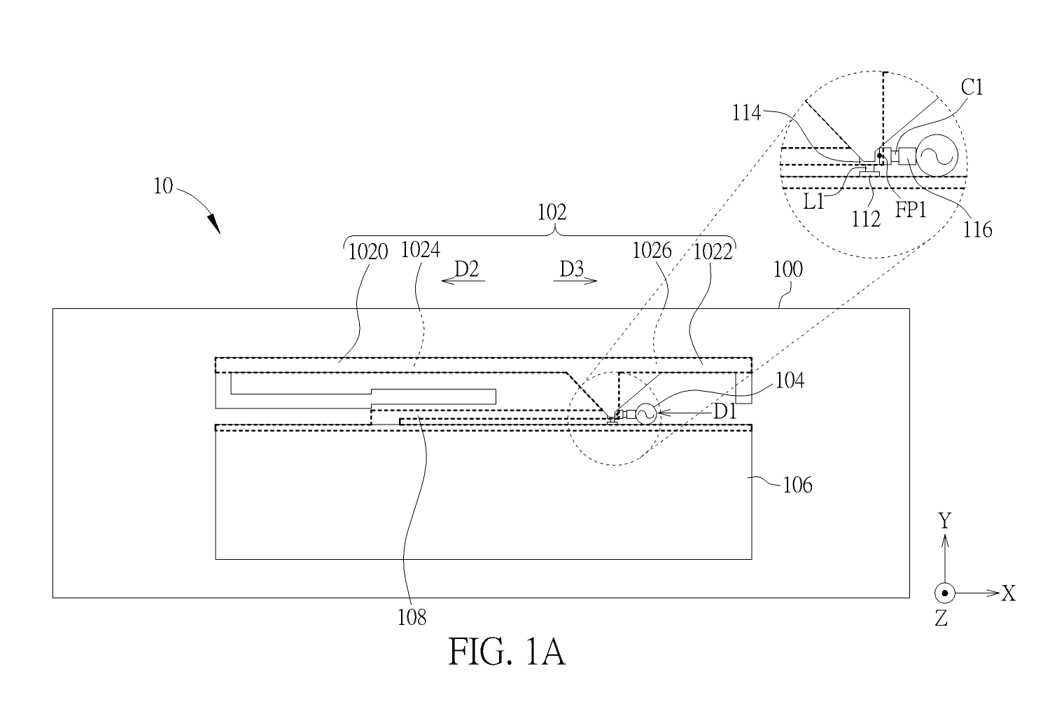

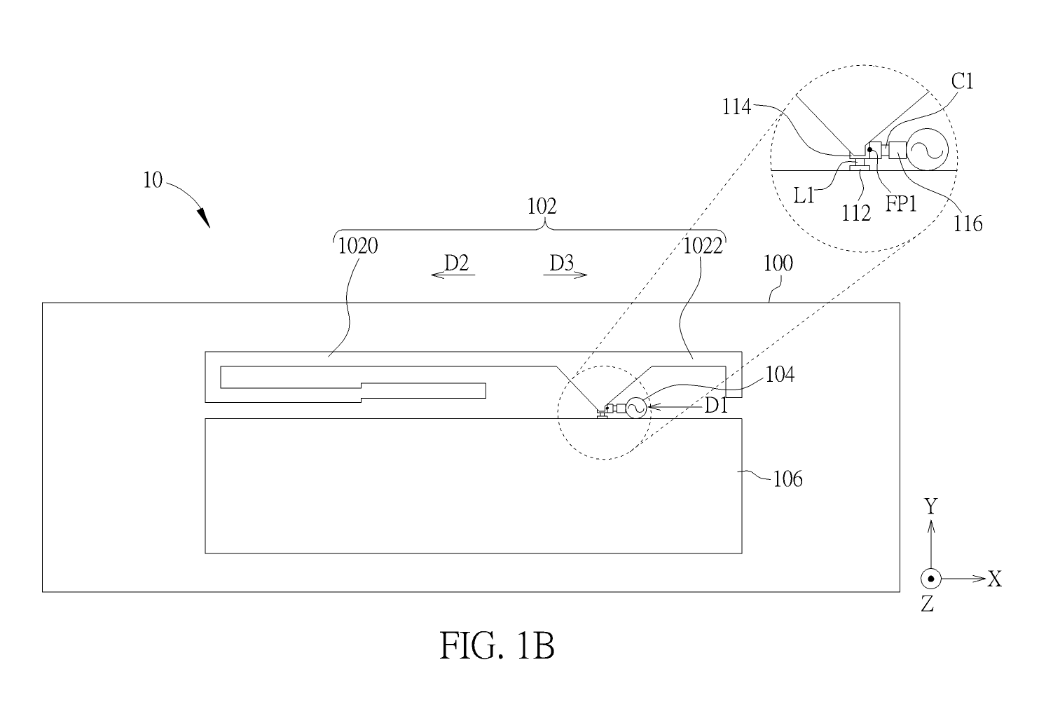

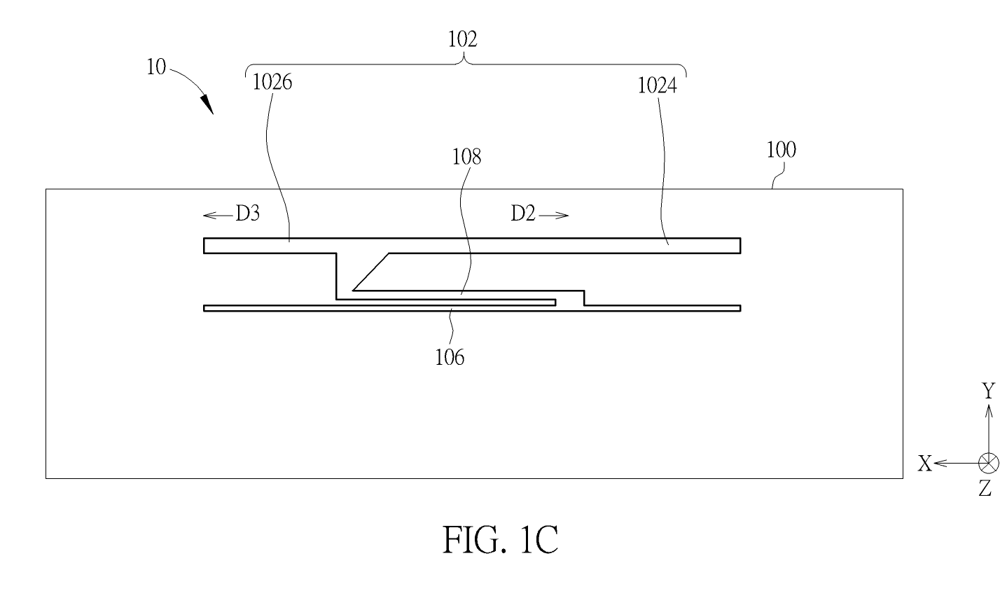

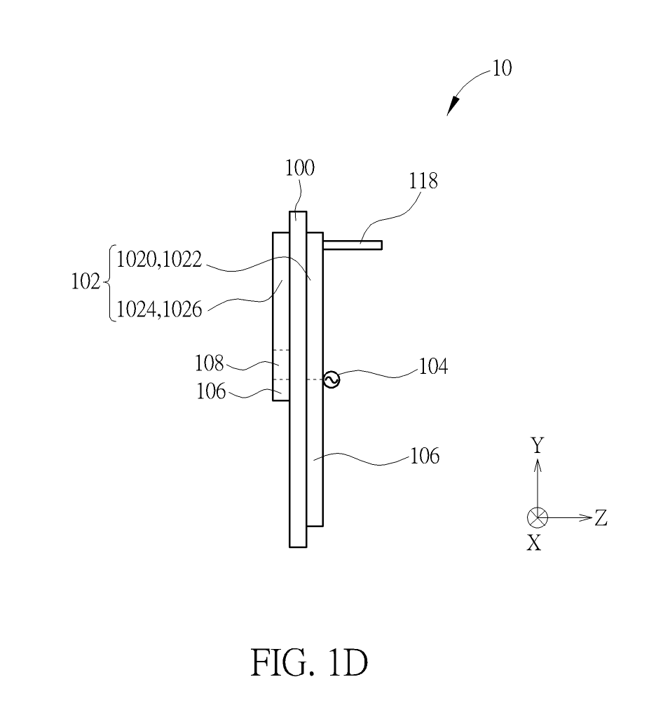

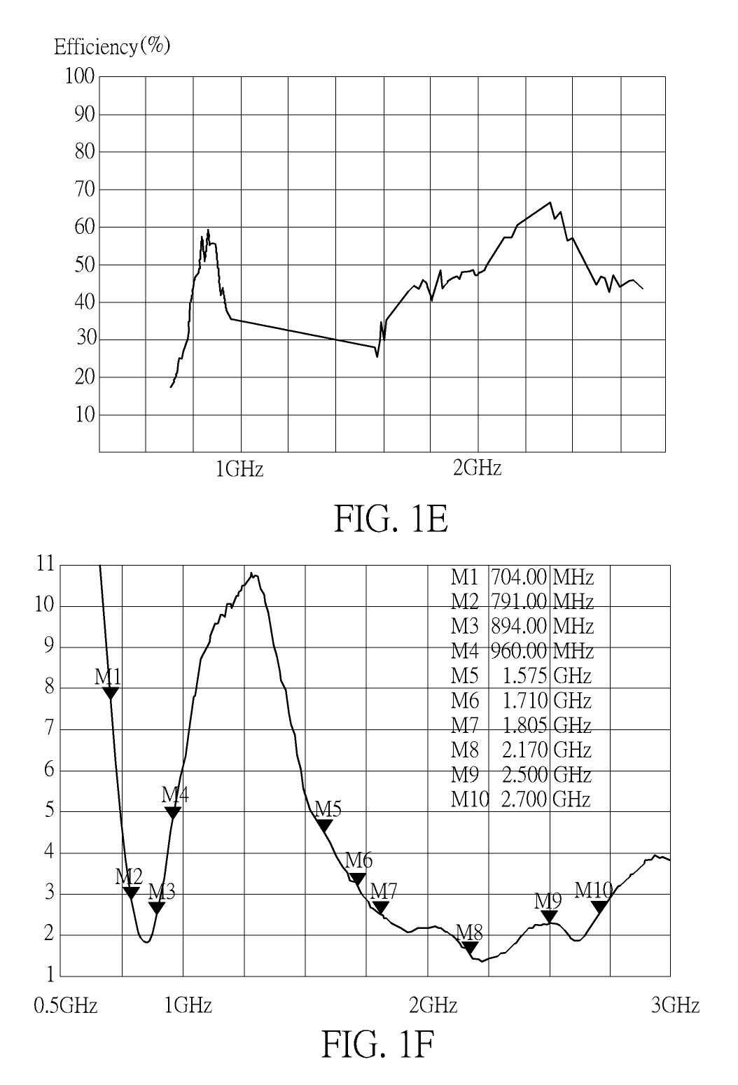

Please refer to FIGS. 1A to 1F, where FIG. 1A is a schematic diagram of a broadband antenna 10 according to an embodiment of the present invention, FIG. 1B illustrates a plane of the broadband antenna 10, FIG. 1C illustrates another plane of the broadband antenna 10, FIG. 1D illustrates a vertical section of the broadband antenna 10, FIG. 1E depicts a diagram of a voltage standing wave radio (VSWR) of the broadband antenna 10, and FIG. 1F depicts a diagram of a radiation efficiency of the broadband antenna 10. The broadband antenna 10 may be used in a wireless communication device for transmitting and receiving wireless signals of multiple different frequency bands such as the LTE/GSM850/GSM900 band (ranging from 791 MHz to 960 MHz) and the GSM1800/GSM1900/UMTS/LTE2300/LTE2500 band (ranging from 1710 MHz to 2700 MHz). The broadband antenna 10 includes a substrate 100, a radiating part 102, a signal feed-in element 104, a grounding unit 106, a shorting unit 108, a feed-in point FP1, a capacitor C1 and an inductor L1. The substrate 100 is a double-sided substrate. The radiating part 102 is disposed on the first plane (e.g. the front side) of the substrate 100 and the shorting unit 108 is disposed on the second plane (e.g. the back side) of the substrate 100. The grounding unit 106 may be two metal sheets connecting to each other, and the two metal sheets may be disposed on the first plane and the second plane of the substrate 100, respectively. The feed-in point FP1 is located on the radiating part 102. Radio signals are transmitted from the signal feed-in element 104 to the radiating part 102 mainly through the feed-in point FP1, and are then emitted to the air. A grounding terminal of the signal feed-in element 104 may be connected with a system grounding unit of the wireless communication device or a grounding terminal of a coaxial cable. The capacitor C1 is electrically connected between the feed-in point FP1 and the signal feed-in element 104. The inductor L1 is electrically connected between the capacitor C1 and the grounding unit 106 (i.e., a terminal of the inductor L1 is electrically connected to the capacitor C1, and another terminal of the inductor L1 is electrically connected to the grounding unit 106). With the passive elements such as the capacitor C1 and the inductor L1, the broadband antenna 10 has more modes of resonance than an antenna without passive elements, and therefore improves the antenna bandwidth and reduces the antenna dimension.

In detail, a terminal of the shorting unit 108 is electrically connected to the radiating part 102, and another terminal of the shorting unit 108 is electrically connected to the grounding unit 106. The radiating part 102 may include a first radiating element 1020 and a second radiating element 1022 on the first plane of the substrate 100, and include a third radiating element 1024 and a fourth radiating element 1026 on the second plane of the substrate 100. The substrate 100 may have one or more vias, which may be located in the area where the radiating part 102 is disposed, for electrically connecting the first radiating element 1020 with the third radiating element 1024 and electrically connecting the second radiating element 1022 with the fourth radiating element 1026. In another embodiment, the one or more vias may be located in the area where the grounding unit 106 is disposed so as to connect with each other the two metal sheets of the grounding unit 106 disposed on the first and the second planes of the substrate 100. As shown in FIG. 1C, the shorting unit 108 may electrically connect the third radiating element 1024 and the fourth radiating element 1026 with the part of the grounding unit 106 disposed on the second plane of the substrate 100. The shorting unit 108, the third radiating element 1024, the fourth radiating element 1026, and the part of the grounding unit 106 disposed on the second plane of the substrate 100 are formed by a single, continuous metal sheet. The shorting unit 108 is formed to extend substantially toward the direction D2. The first radiating element 1020 and the third radiating element 1024 also extend substantially toward the direction D2. The third radiating element 1024 substantially overlaps a projected area which is resulted from projecting the first radiating element 1020 onto the second plane of the substrate 100, and the fourth radiating element 1026 substantially overlaps another projected area which is resulted from projecting the second radiating element 1022 onto the second plane of the substrate 100. The connecting parts 112, 114 and 116 are located around the two terminals of the capacitor C1 and the inductor L1 on the substrate 100 such that the capacitor C1 can be electrically connected between the feed-in point FP1 and the signal feed-in element 104 and the inductor L1 can be electrically connected between the capacitor C1 and the grounding unit 106. The connecting parts 112, 114 and 116 may be metal connecting sheets or solder joints which solder the capacitor C1 and the inductor L1 on the substrate 100.

Since the capacitor C1 is electrically connected between the feed-in point FP1 and the signal feed-in element 104, radio signals from the signal feed-in element 104 are largely transmitted to the feed-in point FP1 via the capacitor C1. The current then flows to the radiating part 102 for emitting the radio signals. In the X-Y plane, the third radiating element 1024 partially overlaps the first radiating element 1020, and the fourth radiating element 1026 partially overlaps the second radiating element 1022. Therefore, radio signals in the radiating elements 1020 and 1022 are coupled to the radiating elements 1024 and 1026. Owing to the coupling effect, the current on the third radiating element 1024 is induced by the current on the first radiating element 1020, and these currents have the same direction. Similarly, the current on the fourth radiating element 1026 is induced by the current on the second radiating element 1022, and these currents have the same direction. As a result, the effective area of the radiating part 102 is increased. Thus, the antenna dimension of the broadband antenna 10 can be reduced while broadband impedance matching is achieved.

FIG. 1D illustrates a vertical section of the broadband antenna 10 which is viewed from the left to the right of the broadband antenna 10 shown in FIG. 1A. FIG. 1D shows that the broadband antenna 10 may further include a metal plate 118 electrically connected to the radiating part 102. The metal plate 118 may be substantially vertical to the plane defined by the radiating part 102, but is not limited herein. The intersection of the metal plate 118 and the radiating part 102 may form any angle smaller than 180 degrees. The metal plate 118 is regarded as an extension of the radiating part 102 along Z-axis, which also radiates electromagnetic waves and therefore increases the effective area of the antenna.

In an embodiment, an electrical length of the first radiating element 1020 is larger than an electrical length of the second radiating element 1022. The first radiating element 1020 and the second radiating element 1022 are connected to each other and are shorted to the grounding unit 106 for resonating at a low frequency band and a high frequency band, respectively. The capacitor C1, together with the first radiating element 1020 and the second radiating element 1022, is used to induce a resonance mode at another high frequency band. In all, the broadband antenna 10 can resonate at least three frequency bands. Moreover, the inductor L1 is used to improve impedance matching of the low frequency band. In some embodiments, an effective capacitance of the capacitor C1 is substantially between 1 pF to 20 pF, and an effective inductance of the inductor L1 is substantially between 1 nH and 20 nH. The signal feed-in element 104 is used to connect to a signal line of a wireless communication system for transmitting radio signals. In order to obtain better radiation pattern, the feed-in direction D1 of the signal feed-in element 104 is substantially parallel to the resonance directions D2 and D3 on the radiating part 102. With appropriate selection for the dimensions of the radiating part 102 and the shorting unit 108 and the values of the capacitor C1 and the inductor L1, the broadband antenna 10 may be designed to comply with wireless communication systems having different operational frequency bands, such as the Long-Term Evolution (LTE) and the Global System for Mobile Communications (GSM). As shown in FIG. 1E, the broadband antenna 10 has broad bandwidth and preferable impedance matching. In addition, the radiation efficiency of the broadband antenna 10 is maintained at around 50% in the operational frequency bands (791 MHz-960 MHz and 1710 MHz-2700 MHz) as shown in FIG. 1F.

Noticeably, the present invention disposes passive elements such as capacitors and inductors in the proximity of the signal feed-in element of the antenna, thereby improving the antenna bandwidth and impedance matching. Those skilled in the art may make modifications and/or alterations accordingly. For example, the substrate 100 may be a printed circuit board, and the components of the broadband antenna 10 shown in FIG. 1A may be printed on the substrate 100. In another example, components such as the first radiating element 1020, the second radiating element 1022, the third radiating element 1024, the fourth radiating element 1026, the grounding unit 106 and the shorting unit 108 may be implemented by metal plates. In addition, the radiating part 102 and the grounding unit 106 disposed on the first and the second planes of the substrate 100 may be electrically connected by using one or more vias or metal wires. The broadband antenna 10 shown in FIG. 1A is an inverted-F antenna, but is not limited herein. The concept of utilizing passive elements such as capacitors and inductors for improving antenna bandwidth and impedance matching maybe applied to various antenna structures, e.g., monopole antenna, dipole antenna, folded dipole antenna or slot antenna.

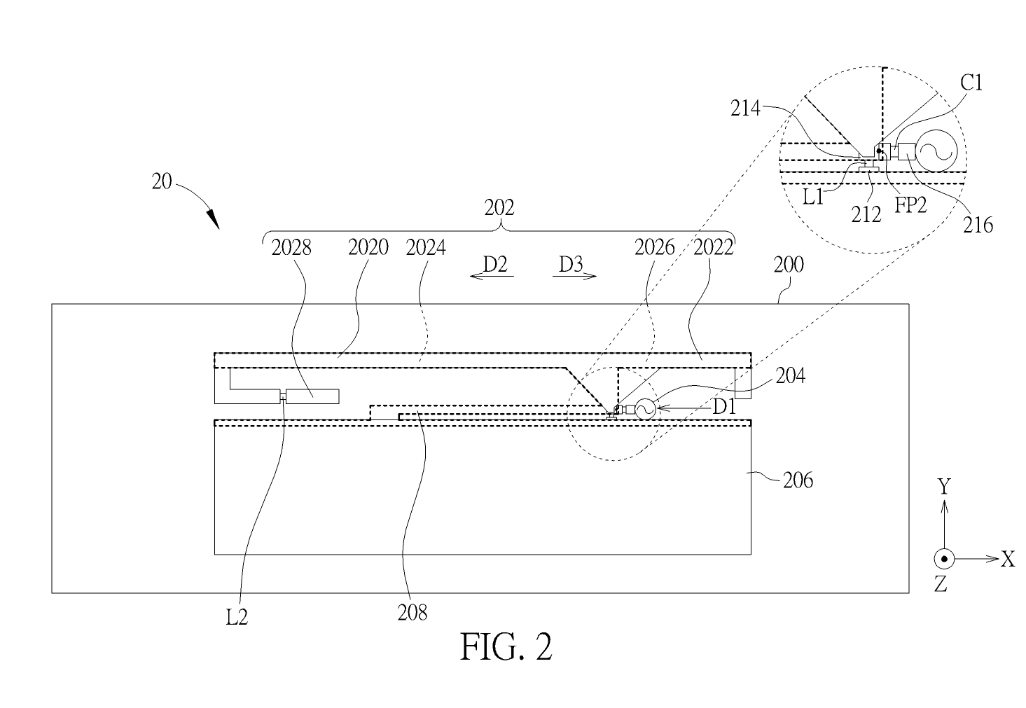

Please refer to FIG. 2, which is a schematic diagram of a broadband antenna 20 according to an embodiment of the present invention. Comparing FIG. 2 with FIG. 1A, the radiating elements of the broadband antenna 20 and the broadband antenna 10 are similar in shape, but the broadband antenna 20 includes one more inductors L2. The radiating part 202 includes a first radiating element 2020, a second radiating element 2022 and a fifth radiating element 2028. The radiating part 202 has a break in between the first radiating element 2020 and the fifth radiating element 2028 (i.e. a branch of the radiating part 202 is separated into two radiating elements 2020 and 2028 by the break). The inductor L2 is disposed across the break, and is electrically connected between the first radiating element 2020 and the fifth radiating element 2028. By adding the inductor L2 to the radiating part 202, the broadband antenna 20 may resonate at an additional high frequency band, and therefore further increases the antenna bandwidth.

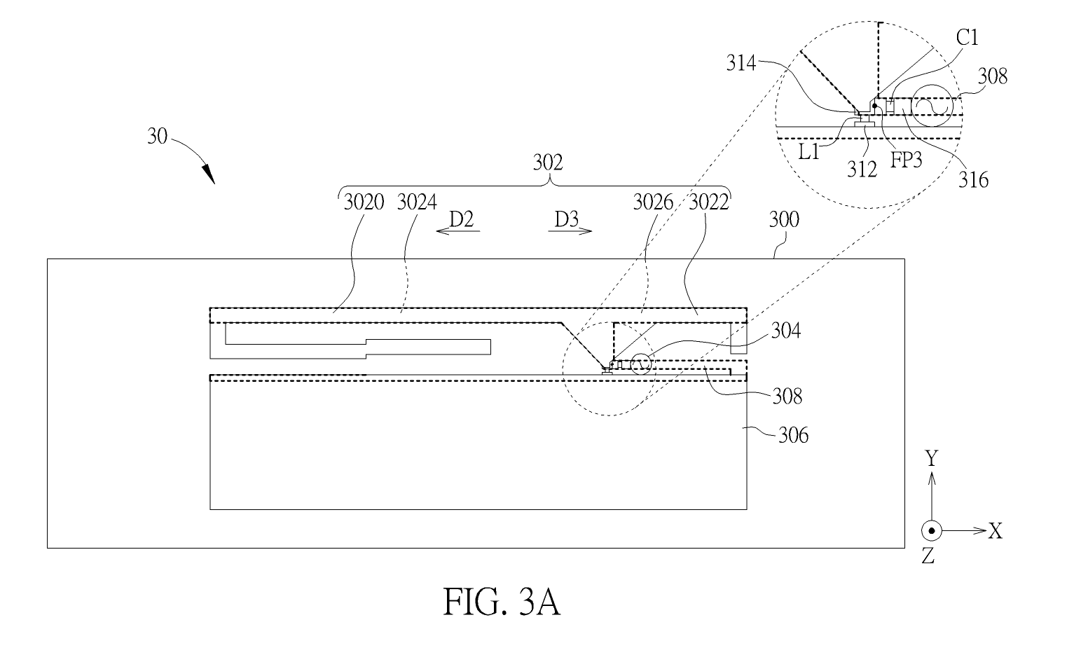

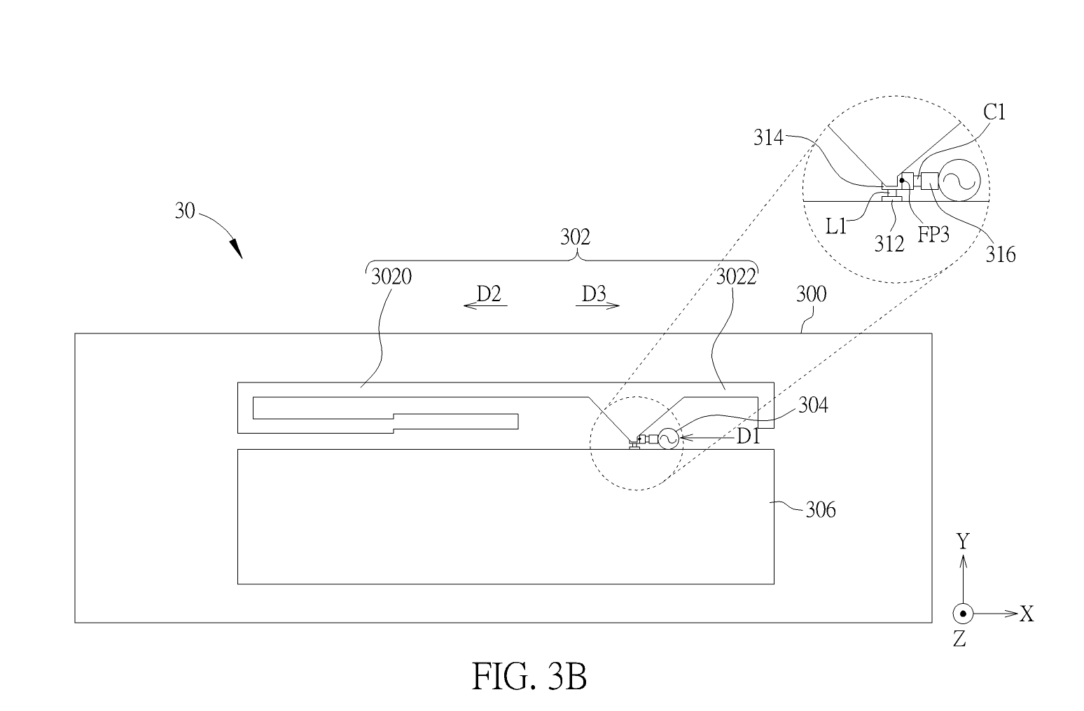

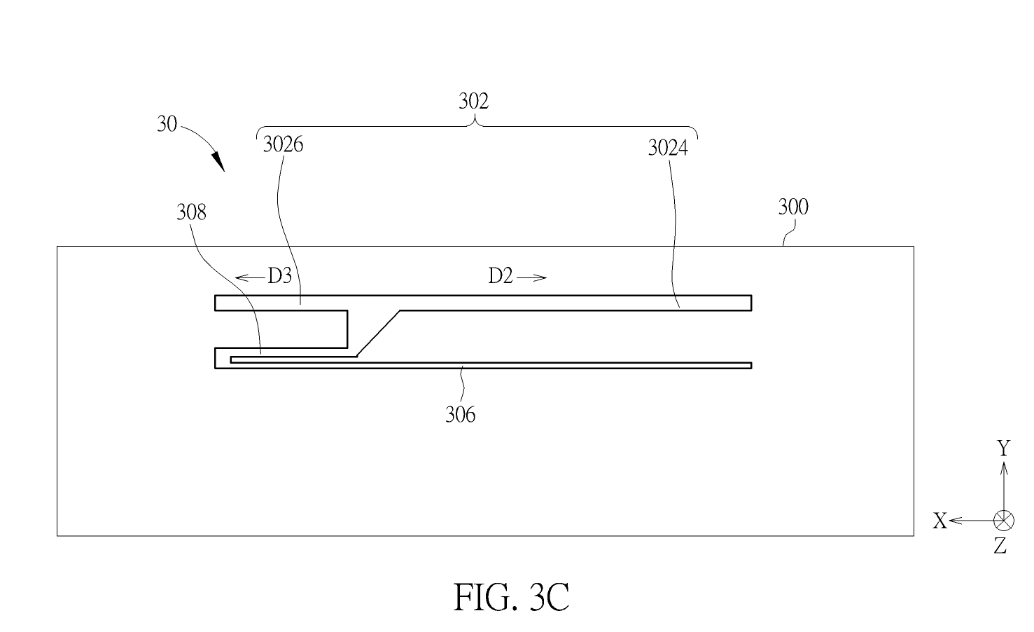

Please refer to FIG. 3A to FIG. 3C. FIG. 3A is a schematic diagram of a broadband antenna 30 according to an embodiment of the present invention, FIG. 3B illustrates a plane of the broadband antenna 30, and FIG. 1C illustrates another plane of the broadband antenna 30. Comparing FIG. 3A to 3C with FIG. 1A to 1C, the radiating elements of the broadband antenna 30 and the broadband antenna 10 are similar in shape, but the shorting unit 308 and the second radiating element 3022 extend toward the same direction D3 whereas the shorting unit 108 and the second radiating element 1022 extend toward the opposite directions. In other words, a horizontal projection result of the second radiating element 3022 (i.e. a result of projecting the second radiating element 3022 to the X-axis) substantially overlaps a horizontal projection result of the shorting unit 308 (i.e. a result of projecting the shorting unit 308 to the X-axis). Since the direction to which the shorting unit 308 extends is changed from the direction D2 to the direction D3, another resonance mode may be induced in the broadband antenna 30. As a result, the broadband antenna 30 may have another operational frequency band which complies with the frequency requirement of another wireless communication system.

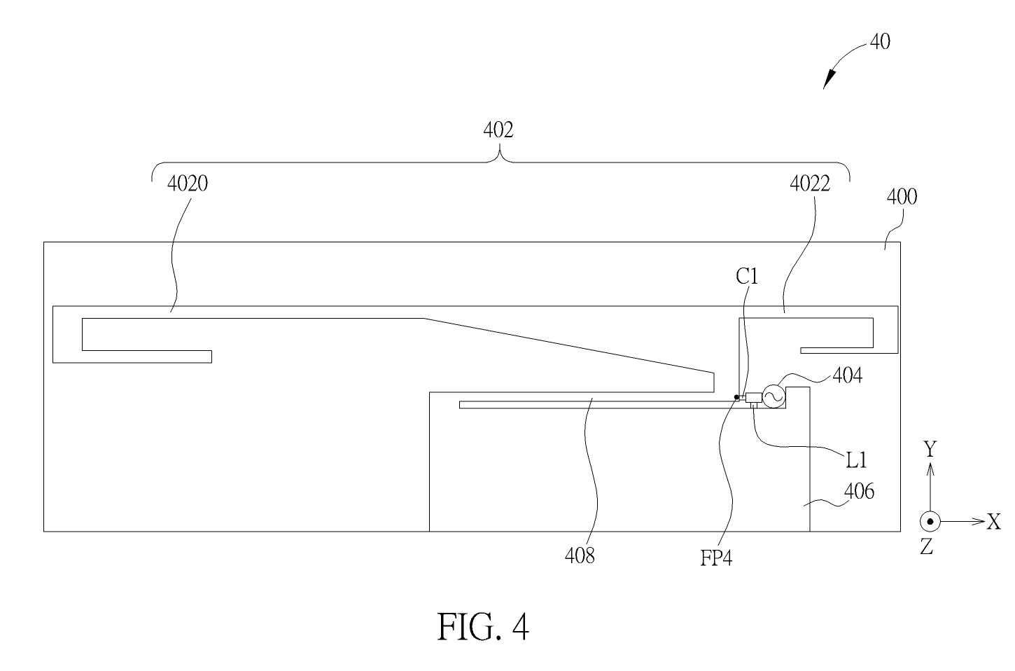

Please refer to FIG. 4, which is a schematic diagram of a broadband antenna 40 according to an embodiment of the present invention. Comparing FIG. 4 with FIG. 1A, the radiating elements of the broadband antenna 40 and the broadband antenna 10 are similar in shape, but in the broadband antenna 10 the radiating part 102 and the shorting unit 108 are disposed on different planes of the substrate 100, whereas in the broadband antenna 40 the radiating part 402 and the shorting unit 408 are disposed on the same plane of the substrate 400. Moreover, in the broadband antenna 10, the conjunction part of the first radiating element 1020 and the second radiating element 1022 extends toward the grounding unit 106, and its shape is an inequilaterally inverted triangle. On the other hand, in the broadband antenna 40, the conjunction part of the first radiating element 4020 and the second radiating element 4022 extends toward the grounding unit 406, and its shape is an inverted right triangle. The shape of the conjunction part of the first radiating element and the second radiating element is not limited herein. In other examples, the shape of the conjunction part may be an inequilaterally inverted triangle or an equilaterally inverted triangle. Alternatively, the shape of the conjunction part may be rectangular, wedge-shaped, triangular, trapezoid, or any geometric shapes combined. The conjunction part may be properly modified according to antenna design requirements in order to adjust the impedance matching of the antenna.

In the aforementioned embodiments, the broadband antennas 10, 20, 30 and 40 are realized in a form of direct feed antenna structure. Radio signals are fed to the first radiating elements 1020, 2020, 3020, 4020 and the second radiating elements 1022, 2022, 3022, 4022 through the feed-in points FP1, FP2, FP3, or FP4. In other embodiments, the broadband antenna of the present invention may be realized in a form of coupling feed antenna structure.

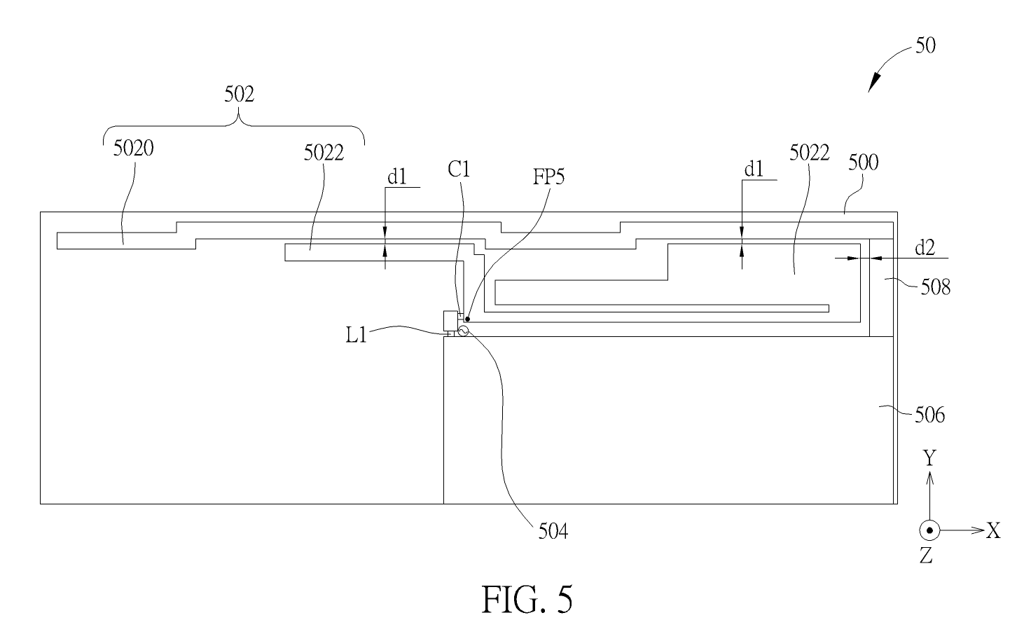

Please refer to FIG. 5, which is a schematic diagram of a broadband antenna 50 according to an embodiment of the present invention. The broadband antenna 50 includes a substrate 500, a radiating part 502, a signal feed-in element 504, a grounding unit 506, a coupling excitation unit 508, a feed-in point FP5, a capacitor C1 and an inductor L1. The radiating part 502 includes a low-frequency radiating element 5020 and a high-frequency radiating element 5022. The feed-in point FP5 is located on the high-frequency radiating element 5022. The low-frequency radiating element 5020 keeps a distance d1 from the high-frequency radiating element 5022 such that radio signals feed in the low-frequency radiating element 5020 from the high-frequency radiating element 5022 by coupling effect. The coupling excitation unit 508 is electrically connected between the low-frequency radiating element 5022 and the grounding unit 506. The coupling excitation unit 508 also keeps a distance d2 from the high-frequency radiating element 5022 so as to enhance the coupling effect between the low-frequency radiating element 5020 and the high-frequency radiating element 5022, which therefore induces different resonance modes. The distances d1 and d2 may be properly adjusted according to the area, shape, location and impedance matching requirements of the low-frequency radiating element 5020, the high-frequency radiating element 5022, and the coupling excitation unit 508. In other words, the distances d1 and d2 do not have to be constant values. A horizontal projection result of the low-frequency radiating element 5020 (i.e. a result of projecting the low-frequency radiating element 5020 to the X-axis) substantially overlaps a horizontal projection result of the high-frequency radiating element 5022 (i.e. a result of projecting the high-frequency radiating element 5022 to the X-axis). In consideration of the limited antenna disposition area and the requirement for better coupling effect and radiation efficiency, the high-frequency radiating element 5022 may be a metal sheet or plate with non-uniform width.

In addition, the antenna radiation frequency, bandwidth and efficiency are closely correlated with the antenna shape and the materials used in the antenna. Therefore, designers may appropriately modify the broadband antennas 10, 20, 30, 40 and 50 to comply with requirements of the wireless communication systems. Note that the examples and embodiments mentioned above are used to illustrate the concept of the present invention, which utilizes passive elements such as capacitors and inductors disposed in the proximity of the signal feed-in element of the antenna for improving the antenna bandwidth and impedance matching. Any alterations and modifications such as varying the material, shape, location of the components should be within the scope of the present invention as long as the concept of the present invention is met.

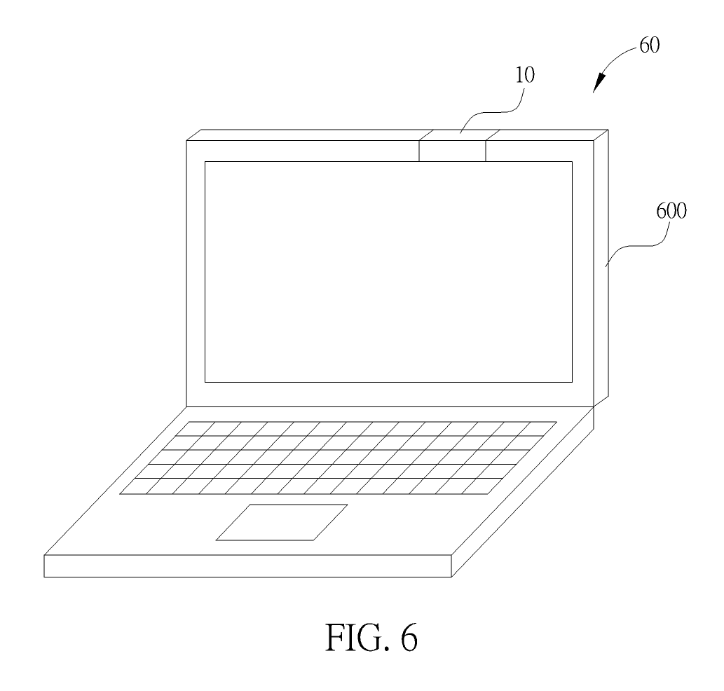

Please refer to FIG. 6, which a schematic diagram of a wireless communication device 60 equipped with the broadband antenna 40 shown in FIG. 1A. The wireless communication device 60 maybe any electronic device having wireless communication functionality such as a cell phone, a tablet PC, a laptop, an electronic reading device, a computer system, and a wireless access point. FIG. 6 simply depicts that the wireless communication device 60 may include a shell 600, the broadband antenna 10 and a radio signal processing unit. The broadband antenna 10 is disposed inside the shell 600, and is used for transmitting and receiving wireless signals in multiple frequency bands so as to allow the wireless communication device 60 to support wireless communication protocols having different operational frequency bands. As such, the wireless communication device 60 can be compatible with different communication specifications regulated in different countries.

In conclusion, the present invention utilizes passive elements such as capacitors and inductors disposed in the proximity of the signal feed-in element of the antenna to induce multiple resonance modes and achieve preferable impedance matching. In this way, the antenna of the present invention can have broader bandwidth and smaller size than its counterparts without passive elements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A broadband antenna for a wireless transceiver, comprising:
a grounding unit, for grounding;
a radiating part;
a signal feed-in element, for transmitting a radio signal to the radiating part in order to emit the radio signal via the radiating part, wherein a grounding terminal of the signal feed-in element is electrically connected to the grounding unit;
a feed-in point, located on the radiating part;
a capacitor, electrically connected between the feed-in point and the signal feed-in element; and
a first inductor, having a first terminal electrically connected to the capacitor.

2. The broadband antenna of claim 1, wherein a second terminal of the first inductor is electrically connected to the grounding unit.

3. The broadband antenna of claim 1, further comprising:
a shorting unit, wherein a first terminal of the shorting unit is electrically connected to the radiating part, and a second terminal of the shorting unit is electrically connected to the grounding unit.

4. The broadband antenna of claim 3, further comprising a substrate, wherein the radiating part and the shorting unit are disposed on a same plane of the substrate.

5. The broadband antenna of claim 3, further comprising a substrate, wherein the radiating part is disposed on a first plane and a second plane of the substrate, and the shorting unit is disposed on the second plane of the substrate.

6. The broadband antenna of claim 5, wherein the substrate has at least one via, located in the area where the radiating part or the grounding unit is disposed, for electrically connecting the radiating part and the grounding unit.

7. The broadband antenna of claim 3, wherein the radiating part comprises:
a first radiating element, extending toward a first direction; and
a second radiating element, electrically connected to the first radiating element, extending toward a second direction different than the first direction;
wherein an electrical length of the first radiating element is larger than an electrical length of the second radiating element, and the shorting unit extends toward the first direction or the second direction.

8. The broadband antenna of claim 7, wherein a conjunction part of the first radiating element and the second radiating element extends toward the grounding unit, and wherein a shape of the conjunction part is rectangular, wedge-shaped, triangular, trapezoid, or geometric combined.

9. The broadband antenna of claim 1, further comprising:
a high-frequency radiating element, comprising the feed-in point; and
a low-frequency radiating element, keeping a distance from the high-frequency radiating element such that the radio signal feeds in the low-frequency radiating element from the high-frequency radiating element by coupling.

10. The broadband antenna of claim 9, further comprising:
a coupling excitation unit, electrically connected between the low-frequency radiating element and the grounding unit.

11. The broadband antenna of claim 9, wherein the high-frequency radiating element is a metal sheet with non-uniform width.

12. The broadband antenna of claim 1, wherein a branch of the radiating part is separated into two radiating elements by a break, and wherein the broadband antenna further comprises a second inductor, electrically connected to the two radiating elements of the radiating part across the break.

13. The broadband antenna of claim 1, wherein an effective capacitance of the capacitor is substantially between 1 pF and 20 pF.

14. The broadband antenna of claim 1, wherein an effective inductance of the first inductor is substantially between 1 nH and 20 nH.

15. The broadband antenna of claim 1, further comprising a metal plate, electrically connected to the radiating part, wherein the intersection of the metal plate and the radiating part forms an angle smaller than 180 degrees.

16. The broadband antenna of claim 1, wherein a feed-in direction of the signal feed-in element is parallel to a resonance direction of the radio signal on the radiating part.
